(19) United States
(12) Patent Application Publication
(10) Pub. No.: US 2026/0205549 A1
(43) Pub. Date: Jul. 16, 2026

(54) IMAGE READING APPARATUS

(71) Applicant: SEIKO EPSON CORPORATION, TOKYO (JP)

(72) Inventor: Sekito MASARU, KITAKYUSHU-SHI (JP)

(21) Appl. No.: 19/442,214

(22) Filed: Jan. 7, 2026

(30) Foreign Application Priority Data
Jan. 10, 2025 (JP) 2025-003943

(51) Int. Cl. H04N 1/00

(52) U.S. Cl. CPC H04N 1/00559; H04N 1/00408; H04N 1/00525; H04N 1/00543; H04N 1/00551; H04N 1/00557; H04N 2201/0081

(57) ABSTRACT

An image reading apparatus includes a sensor unit that reads an image of a document, a conveyance roller that is disposed at a position facing the sensor unit and conveys the document, a housing that houses the sensor unit and the conveyance roller, an operation unit that is disposed in the housing and is operable by a user, and a magnet capable of holding an apparatus main body including the sensor unit, the conveyance roller, and the housing on a magnetic material, wherein the sensor unit and the conveyance roller are disposed between the operation unit and the magnet in a direction intersecting an installation surface of the apparatus main body, and a holding force of the magnet is larger than a weight of the apparatus main body.

The present application is based on, and claims priority from JP Application Serial Number 2025-003943, filed January 10, 2025, the disclosure of which is hereby incorporated by reference herein in its entirety.

### BACKGROUND

### 1. Technical Field

The present disclosure relates to an image reading apparatus.

### 2. Related Art

JP-A-2019-193217 discloses a configuration of a scanner used in an attitude in which a document conveyance path is disposed along a horizontal direction.

JP-A-2019-193217 is an example of the related art.

However, in the configuration described in JP-A-2019-193217, it is necessary to place the scanner in an attitude in which the document conveyance path extends along the horizontal direction, that is, on a horizontal surface of a desk or the like. Accordingly, a space for placement of the scanner is required to be provided on the desk, and the work on the desk is difficult to do.

### SUMMARY

An image reading apparatus includes a reading unit that reads an image of a document, a document conveyance unit that is disposed at a position facing the reading unit and conveys the document, a housing that houses the reading unit and the document conveyance unit, an operation unit that is disposed in the housing and is operable by a user, and a magnet capable of holding an apparatus main body including the reading unit, the document conveyance unit, and the housing on a magnetic material, wherein the reading unit and the document conveyance unit are disposed between the operation unit and the magnet in a direction intersecting an installation surface of the apparatus main body, and a holding force of the magnet is larger than a weight of the apparatus main body.

### BRIEF DESCRIPTION OF THE DRAWINGS

FIG. 1 is a perspective view showing a configuration of a scanner.

FIG. 2 is a perspective view showing the configuration of the scanner.

FIG. 3 is a cross-sectional view taken along line A-A of the scanner shown in FIG. 1.

FIG. 4 is a cross-sectional view taken along line B-B of the scanner shown in FIG. 1.

FIG. 5 is a perspective view showing a configuration of the scanner including a reversing member.

FIG. 6 is a perspective view showing the configuration of the scanner including the reversing member.

FIG. 7 is a cross-sectional view showing the configuration of the scanner shown in FIG. 5.

FIG. 8 is a cross-sectional view showing the configuration of the scanner shown in FIG. 6.

FIG. 9 is a perspective view showing a structure of the reversing member.

FIG. 10 is a flowchart showing a method of using the scanner.

FIG. 11A is a cross-sectional view illustrating a first attitude of the scanner.

FIG. 11B is a cross-sectional view illustrating the first attitude of the scanner.

FIG. 12A is a schematic view illustrating a condition of use of the scanner.

FIG. 12B is a schematic view illustrating a condition of use of the scanner.

FIG. 13 is a perspective view showing a configuration of a scanner according to a modification.

FIG. 14 is a perspective view showing a configuration of a scanner according to a modification.

FIG. 15 is a perspective view showing a configuration of a scanner according to a modification.

FIG. 16A is a cross-sectional view showing a configuration of a scanner according to a modification.

FIG. 16B is a cross-sectional view showing the configuration of the scanner according to the modification.

### DESCRIPTION OF EMBODIMENTS

Hereinafter, a configuration of a scanner 1 as an image reading apparatus will be described with reference to the drawings. In the drawings used in the following description, three axes orthogonal to one another will be described as an X axis, a Y axis, and a Z axis. Directions along the X axis are referred to as "X directions", directions along the Y axis are referred to as "Y directions", and directions along the Z axis are referred to as "Z directions". The direction of an arrow is referred to as a + direction, and the direction opposite to the + direction is referred to as a - direction. A view from the +Z direction or the -Z direction is also referred to as a plan view or planar. The "Y direction" is a direction in which a document is conveyed from a document insertion port 5 to a document ejection port 6. The "X direction" is an apparatus width direction intersecting the Y direction. The "Z direction" is a direction from the installation surface toward an upper surface 4a.

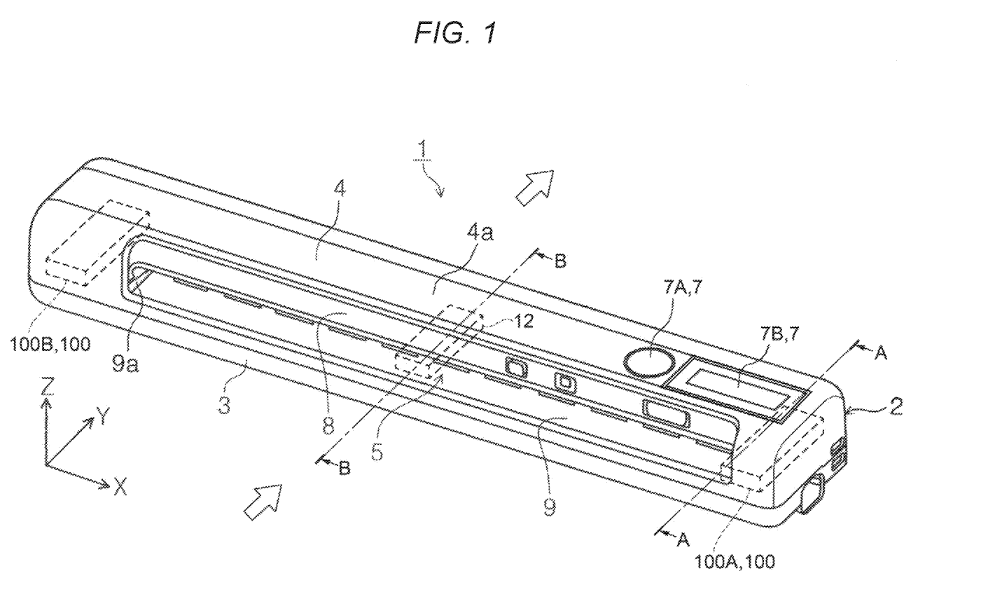

First, the configuration of the scanner 1 will be described with reference to FIGS. 1 to 4. White arrows indicate the conveyance direction of the document.

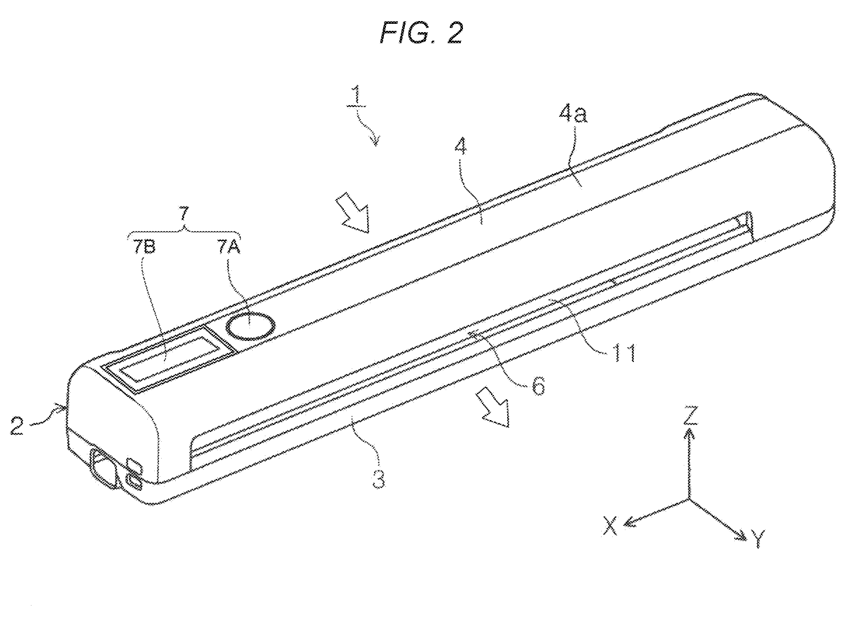

As illustrated in FIGS. 1 and 2, the scanner 1 is a handy type that is easy to carry. The housing of the scanner 1 includes a lower housing 3 and an upper housing 4. The entire structure surrounded by the lower housing 3 and the upper housing 4 is referred to as an apparatus main body 2. The housing is also referred to as the apparatus main body 2.

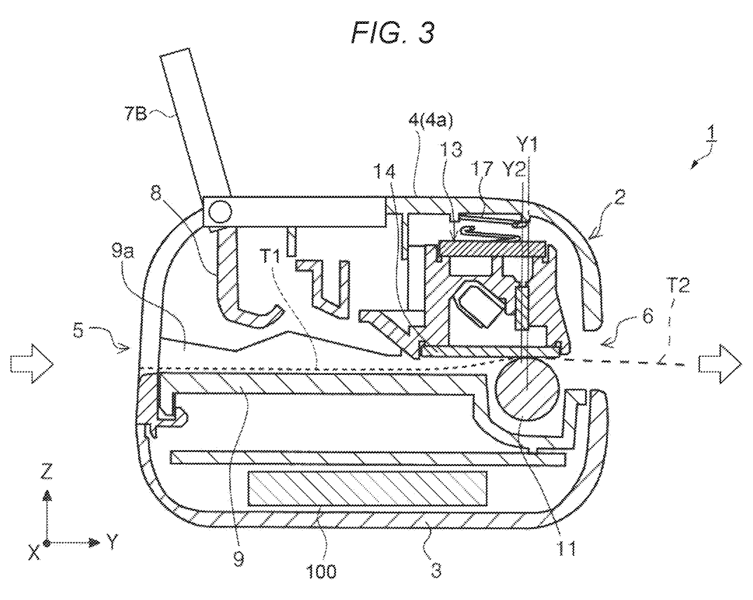

An operation unit 7 that receives an operation input is provided on the upper surface 4a of the apparatus main body 2 in the +X direction. The operation unit 7 includes a scan button 7A and a panel 7B for displaying various kinds of information. The panel 7B is, for example, of a tilt type, and the angle of the panel 7B can be changed so that a user can easily see the panel (see FIG. 3).

The document insertion port 5 for insertion of a document is formed between a path forming member 9 and a top frame 8. As illustrated in FIG. 2, the document ejection port 6 is formed between the upper housing 4 and the lower housing 3. A part of a conveyance roller 11 as a document conveyance unit is exposed inside the document ejection port 6.

As illustrated in FIG. 3, a document conveyance path T1 is a path for conveying a document, and is formed with the path forming member 9. The top frame 8 and a sensor unit 13 as a reading unit are disposed above the document conveyance path T1. The sensor unit 13 is disposed at a position facing the conveyance roller 11. A document ejection path T2 is provided adjacent to the document conveyance path T1. The document conveyance path T1 and the document ejection path T2 extend substantially horizontally.

A magnet 100 that can be held by a magnetic material is disposed below the path forming member 9. Specifically, the single magnet 100 is disposed at each of two positions in the +X direction and the -X direction at the downside of the path forming member 9. One magnet 100A is disposed on the lower housing 3 in the +X direction (see FIG. 1). The other magnet 100 B is disposed on the lower housing 3 in the -X direction (see FIG. 1).

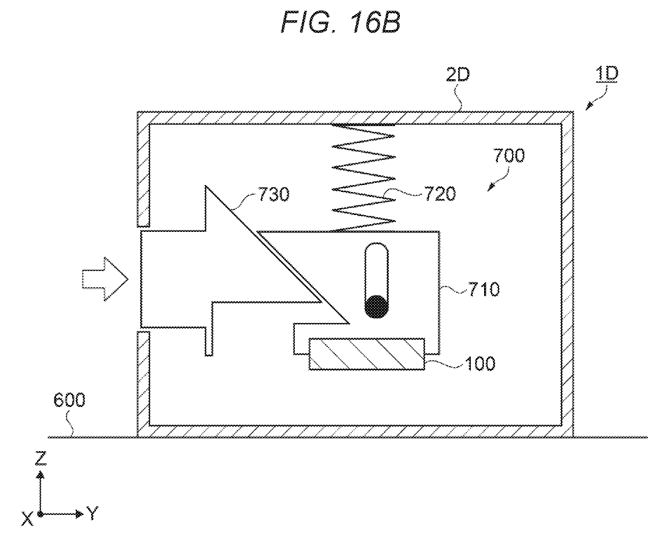

The holding force of the magnet 100 is larger than the weight of the apparatus main body 2. The sensor unit 13 and the conveyance roller 11 are disposed between the operation unit 7 and the magnets 100 in a direction intersecting an installation surface 600 (see FIG. 16A) of the apparatus main body 2. Specifically, the sensor unit 13 overlaps at least part of the magnets 100 when viewed from the Z direction.

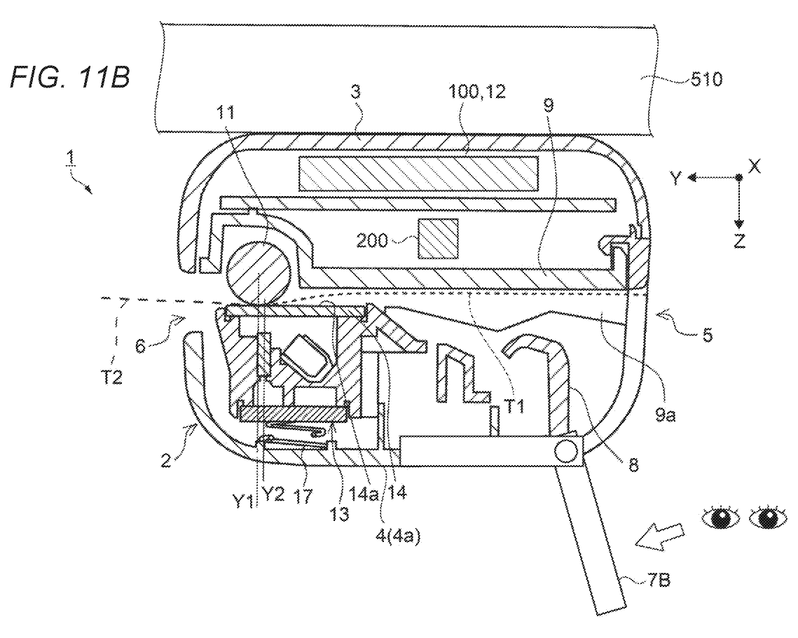

As described above, since the magnets 100 having a larger holding force than the weight of the apparatus main body 2 are disposed on the lower housing 3 inside the scanner 1, in other words, on the bottom of the apparatus main body 2, the scanner 1 can be attached to a location where a magnetic material is provided, for example, a back surface 510 of a desk 500 (see FIG. 12B) , a wall 410 (see FIG. 12A), or the like. Therefore, it is possible to improve the degree of freedom of the installation location, and for example, it is possible to effectively use the space on the desk for other than the scanner 1.

Further, since the magnets 100 are disposed in the housing, in other words, inside the apparatus main body 2, it is possible to suppress adhesion of dust having a magnetic material to the magnets 100 and to maintain the magnetic force of the magnets 100 as compared with a case where the magnets 100 are disposed outside the apparatus main body 2.

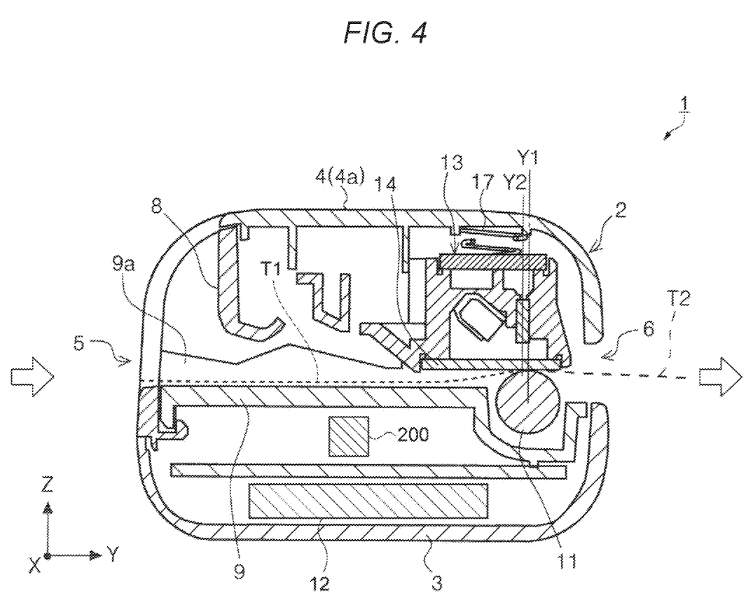

As shown in FIG. 4, a control unit 12 is provided below the path forming member 9. The control unit 12 is formed by providing a plurality of electronic components on a circuit board, and performs various kinds of control including conveyance, reading, and ejection of a document in the scanner 1. The control unit 12 controls a display method of the panel 7B based on a detection result of a gyro sensor 200 as a detection unit attached to the scanner 1.

The gyro sensor 200 is disposed below the path forming member 9. The gyro sensor 200 includes, for example, a sensor element using a quartz crystal vibrator. The sensor element includes a drive arm that performs drive vibration by application of a drive signal and a detection arm that performs detection vibration by a Coriolis force and outputs a signal having a magnitude corresponding thereto. The detection unit is not limited to the gyro sensor 200 and may be an acceleration sensor or the like.

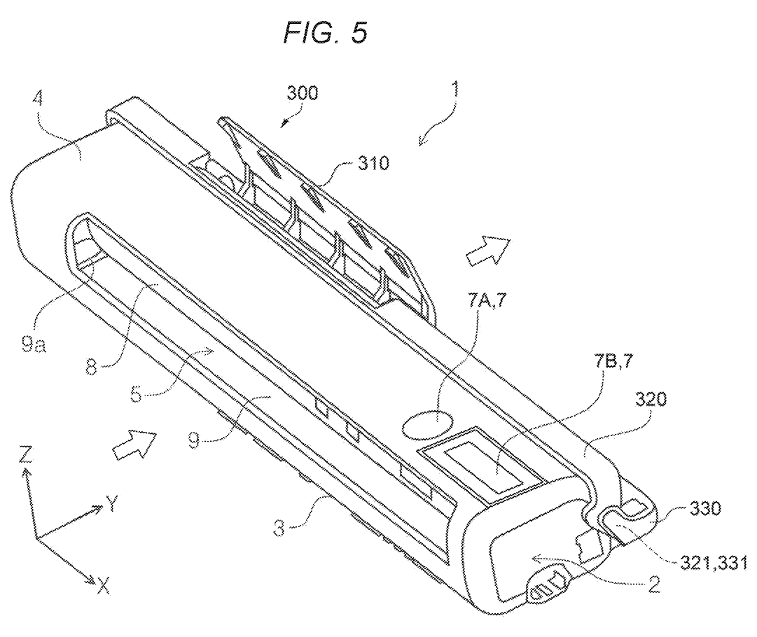

As described above, since the gyro sensor 200 is provided in the scanner 1 and display related to the attachment and detachment of a reversing member 300 (see FIG. 5) is performed on the panel 7B according to the attitude of the apparatus main body 2, the user can attach and detach the reversing member 300 according to the display. Therefore, it is possible to suppress the occurrence of problems such as a paper jam or a fall of a document depending on the attitude of the scanner 1.

The document conveyance path T1 is a path from the document insertion port 5 to a position Y1. The document ejection path T2 is a path downstream of the position Y1.

The document inserted from the document insertion port 5 is supported by the path forming member 9 and moves to a nip position between the conveyance roller 11 and the sensor unit 13. When the user using the scanner 1 inserts a document from the document insertion port 5, the user inserts the document while abutting a side edge of the document in the -X direction against an edge guide 9a provided at an end portion in the -X direction. Thus, the position of the document in the X-axis direction is determined.

When the user inserts the document, the user can obtain a feeling of abutment by the front end of the document reaching the nip position between the conveyance roller 11 and the sensor unit 13, or the front end of the document coming into contact with the conveyance roller 11. A document sensor (not illustrated) is provided upstream of the conveyance roller 11.

As illustrated in FIG. 3, a compression spring 17 that exerts a pressing force between the sensor unit 13 and the upper housing 4 is provided in an upper part of the sensor unit 13. The sensor unit 13 is pressed downward by the compression spring 17. Accordingly, a glass plate 14 is pressed against the conveyance roller 11.

The position Y1 is a rotation center position of the conveyance roller 11 in the Y-axis direction. The position Y1 is also a contact center position between the conveyance roller 11 and the glass plate 14. A position Y2 is a document reading position by the sensor unit 13 in the Y-axis direction. The position Y2 is slightly upstream of the position Y1.

The reading position Y2 is located in a contact region between the conveyance roller 11 and the glass plate 14 due to deformation of the conveyance roller 11. The read document is ejected from the document ejection port 6 toward the rear of the apparatus along the document ejection path T2 by the rotation of the conveyance roller 11.

Next, a configuration of the reversing member 300 will be described with reference to FIGS. 5 to 9.

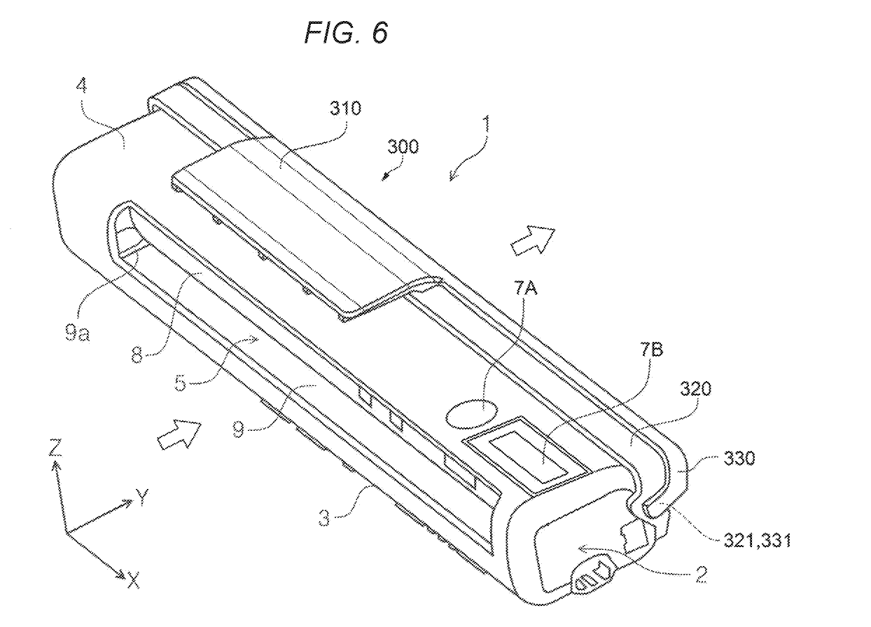

As illustrated in FIGS. 5 and 6, the scanner 1 is detachably provided with the reversing member 300 for ejecting the document in a direction in which the document is inserted, specifically, in the -Y direction when the document is ejected.

Specifically, the reversing member 300 is detachably disposed near the document ejection port 6. The reversing member 300 comes into contact with the leading end of the document ejected from the document ejection port 6 and sends the document in a direction opposite to the direction in which the document is ejected. The reversing member 300 includes a guide portion 310, an attachment adapter 320, and a support portion 330.

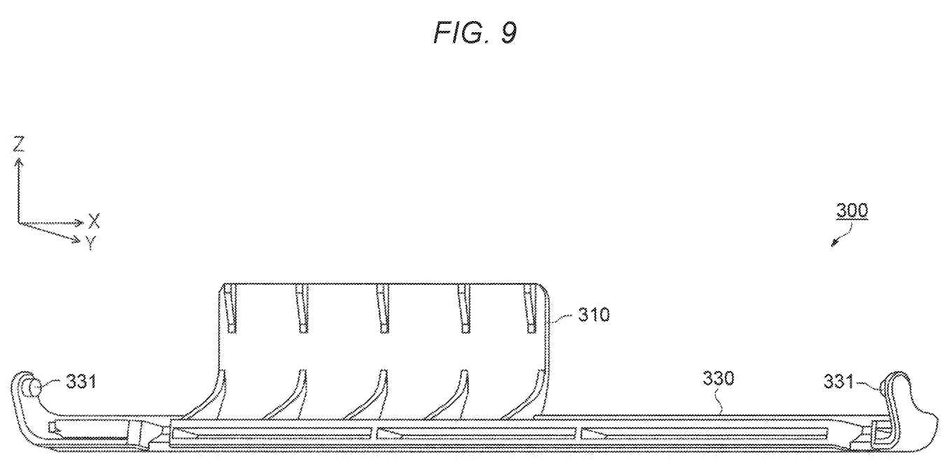

As illustrated in FIG. 9, the support portion 330 has a shape extending in the X-axis direction, and includes shaft portions 331 at both end portions in the X-axis direction. As shown in FIGS. 5 and 6, the attachment adapter 320 has a shape extending in the X-axis direction, and includes fitting holes 321 at both end portions in the X-axis direction.

When the shaft portion 331 of the support portion 330 is fitted into the fitting hole 321 of the attachment adapter 320, the support portion 330 is supported so as to be rotatable in the Y-Z plane around the rotation axis parallel to the X-axis direction.

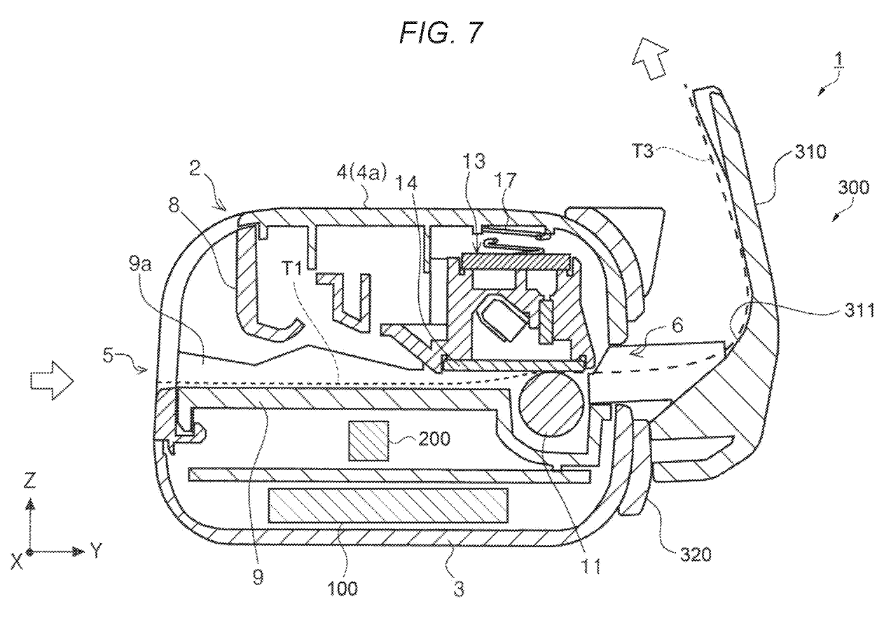

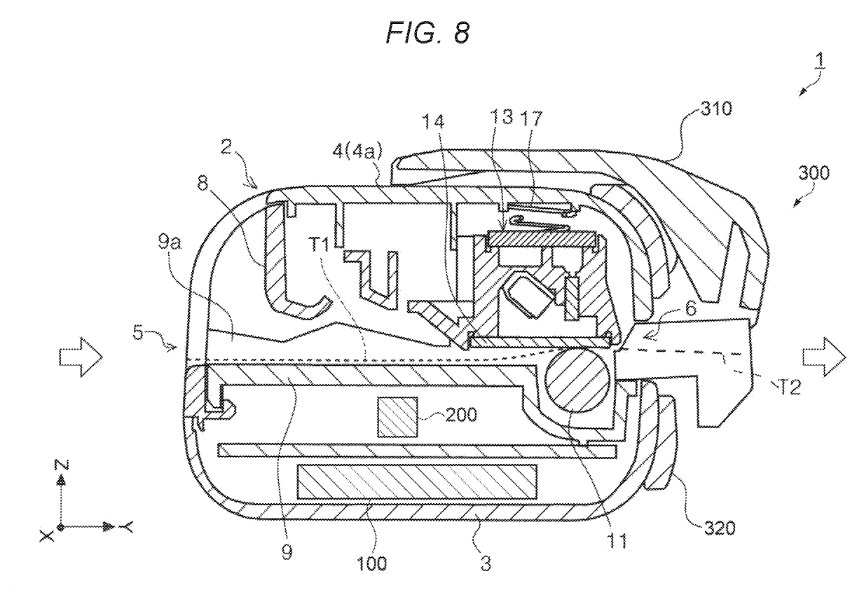

As shown in FIGS. 5 to 8, the guide portion 310 can be switched between an open state (see FIGS. 5 and 7) and a closed state (see FIGS. 6 and 8) by being pivoted.

As illustrated in FIG. 7, the reversing member 300 in the open state is at a position where the reversing member abuts against the leading end of the document ejected from the document ejection port 6. The document ejected from the document ejection port 6 in the +Y direction is guided upward by a guide surface 311, and is further guided so as to be reversed in the -Y direction.

A sign T3 denotes a document guide path formed by the reversing member 300. By attaching the reversing member 300 to the apparatus main body 2 and opening the reversing member, a space for ejection of a document to the rear of the apparatus main body 2 can be suppressed, and an installation space for the apparatus main body 2 can be saved.

In this way, by attaching the reversing member 300, it is possible to prevent the read document from being returned toward the user or the document from being jammed in the document ejection port 6. Further, when the reversing member 300 is not required, the reversing member can be removed, and the space can be effectively used.

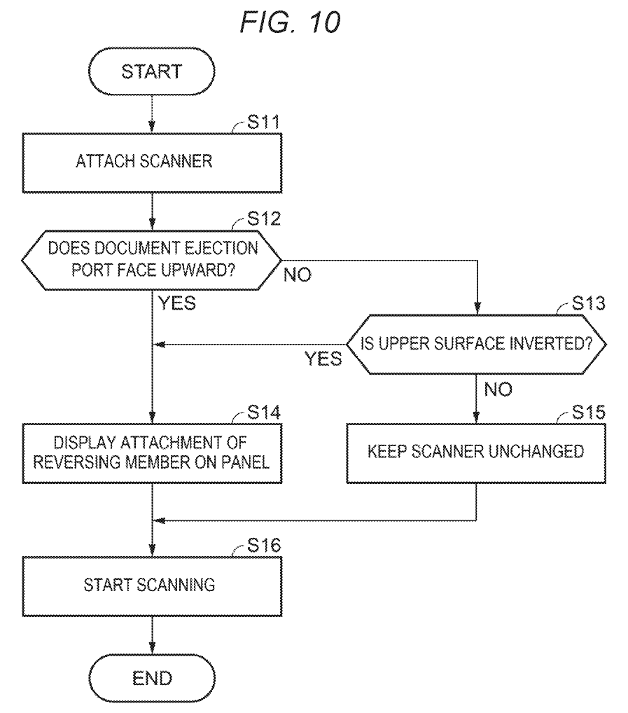

Next, a method of using the scanner 1 will be described with reference to FIGS. 10, 11A, 11B, 12A, and 12B. In the present embodiment, a method of using the scanner 1 when the scanner is not used on a desk and is attached to the back surface 510 of the desk (see FIG. 12B) and when the scanner is attached to the wall 410 (see FIG. 12A) will be described.

As shown in FIG. 10, in step S11, the scanner 1 is attached. Specifically, the scanner 1 is attached to a metal portion of the back surface 510 of the desk 500 or a metal portion of the wall 410 using the magnets 100 disposed in the scanner 1.

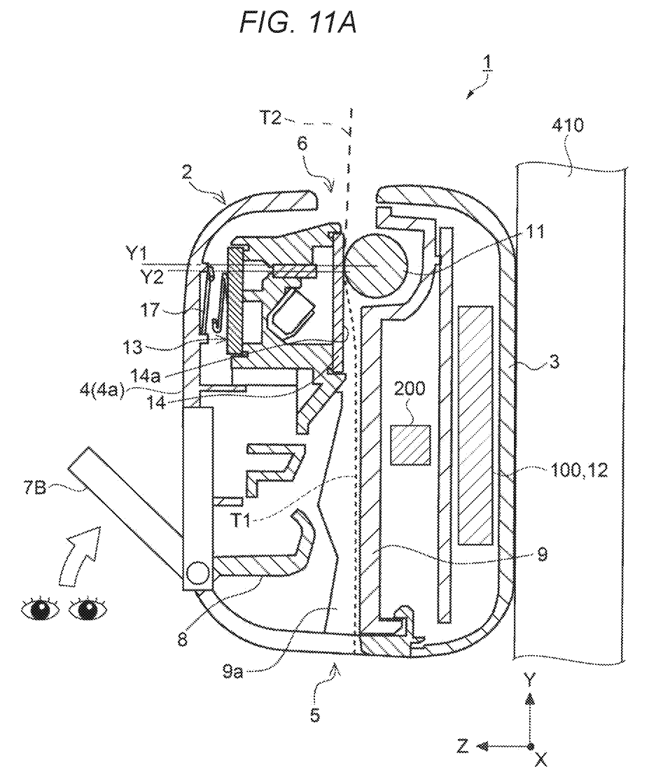

In step S12, whether the document ejection port 6 faces upward is determined. In other words, the orientation of the scanner 1 is determined. Specifically, the control unit 12 causes a determination unit (not illustrated) to determine whether the document ejection port 6 of the scanner 1 faces upward, that is, is in a first attitude (see FIG. 11A) based on the detection result of the gyro sensor 200.

As illustrated in FIG. 11A, when the scanner 1 is attached to the wall 410 and the document ejection port 6 faces upward, the process proceeds to step S14. When the document ejection port 6 does not face upward, the process proceeds to step S13. "The scanner 1 is attached to the wall 410" refers to a state in which the scanner 1 is attached such that the upper surface 4a is along the vertical direction.

In step S13, whether the upper surface 4a (see FIG. 11B) of the scanner 1 is inverted is determined. In other words, whether the scanner 1 is attached to the back surface 510 of the desk 500 is determined. Specifically, the control unit 12 causes the determination unit (not illustrated) to determine whether the upper surface 4a of the scanner 1 is in an inverted state, that is, the first attitude based on the detection result of the gyro sensor 200.

As illustrated in FIG. 11B, when the scanner 1 is attached to the back surface 510 of the desk 500 and the upper surface 4a of the scanner 1 is inverted, the process proceeds to step S14. When the scanner 1 is not attached to the back surface 510 of the desk 500, the process proceeds to step S15. "The upper surface 4a of the scanner 1 is inverted" refers to a state in which the upper surface 4a of the scanner 1 is located below.

In step S14, the panel 7B of the scanner 1 is caused to display a recommendation to attach the reversing member 300. Specifically, since the scanner 1 is in the first attitude, that is, the scanner is attached to the wall 410 of a locker 400, or the scanner 1 is attached to the back surface 510 of the desk 500, the control unit 12 notifies the user by causing the panel 7B to display an instruction to attach the reversing member 300 to the scanner 1.

In step S15, the scanner 1 is kept unchanged, that is, the reversing member 300 is not attached. In other words, for example, when the scanner 1 is disposed on a desk, the reversing member 300 is not attached.

In step S16, scanning is started. Specifically, when the user presses the scan button 7A of the scanner 1, the document is scanned.

As described above, when the scanner 1 is in the first attitude, that is, when the scanner is attached to the wall 410 of the locker 400 or when the scanner 1 is attached to the back surface 510 of the desk 500, the reversing member 300 is attached to the scanner 1, and thus it is possible to prevent the read document from being returned toward the user or the document from being jammed in the document ejection port 6.

As described above, the scanner 1 includes the sensor unit 13 that reads an image of a document, the conveyance roller 11 that is disposed at a position facing the sensor unit 13 and conveys the document, the housing that houses the sensor unit 13 and the conveyance roller 11, the operation unit 7 that is disposed in the housing and operable by a user, and the magnet 100 configured hold the apparatus main body 2 including the sensor unit 13, the conveyance roller 11, and the housing to a magnetic material, wherein the sensor unit 13 and the conveyance roller 11 are disposed between the operation unit 7 and the magnet 100 in a direction intersecting the installation surface 600 of the apparatus main body 2, and the holding force of the magnet 100 is larger than the weight of the apparatus main body 2.

According to the configuration, since the apparatus main body 2 includes the magnets 100 having a larger holding force than the weight of the apparatus main body 2, the apparatus main body 2 can be installed in a location where a magnetic material is provided, for example, the back surface 510 of the desk 500 or the wall 410 of the locker 400. Therefore, it is possible to improve the degree of freedom of the installation location, and for example, it is possible to effectively use the installation surface 600, that is, the space on the desk. Further, it is possible to secure a foot space when the scanner 1 is used and to realize space saving when the scanner 1 is stored.

In the scanner 1 of the present embodiment, the magnets 100 are preferably disposed inside the apparatus main body 2. According to the configuration, since the magnets 100 are disposed inside the apparatus main body 2, it is possible to suppress adhesion of dust having a magnetic material to the magnets 100, and to maintain the magnetic force of the magnets 100 as compared with a case where the magnets 100 are disposed outside the apparatus main body 2.

Further, the scanner 1 of the present embodiment preferably includes the document ejection port 6 that ejects the document, and the reversing member 300 that is detachably disposed near the document ejection port 6, comes into contact with the leading end of the document ejected from the document ejection port 6, and sends the document in the direction opposite to the direction in which the document is ejected. According to the configuration, by attaching the reversing member 300, it is possible to prevent the read document from being returned toward the user or the document from being jammed in the document ejection port 6. Further, when the reversing member 300 is not required, the reversing member can be removed, and the space can be effectively used.

In the scanner 1 of the present embodiment, it is preferable that the gyro sensor 200 that detects the attitude of the apparatus main body 2 and the control unit 12 that performs control based on the detection result of the gyro sensor 200 are provided, and the control unit 12 causes the operation unit 7 to perform display related to attachment and detachment of the inversing member 300 based on the detection result of the gyro sensor 200. According to the configuration, since the display related to the attachment and detachment of the reversing member 300 is performed according to the attitude of the apparatus main body 2, the user can attach and detach the reversing member 300 according to the display, and it is possible to suppress the occurrence of a problem due to the orientation of the attitude. For example, it is possible to prevent the document from being jammed in the document ejection port 6 or the document from falling.

In the scanner 1 of the present embodiment, the detection unit is preferably the gyro sensor 200. According to the configuration, since the gyro sensor 200 is used, the attitude of the apparatus main body 2 can be detected with higher accuracy.

In the scanner 1 of the present embodiment, when the gyro sensor 200 determines that the attitude of the apparatus main body 2 is the first attitude, it is preferable that the control unit 12 causes the operation unit 7 to display a recommendation to attach the reversing member 300. According to the configuration, when the apparatus main body 2 is in the first attitude, for example, when the document ejection port 6 faces upward or when the apparatus main body 2 is inverted, attachment of the reversing member 300 is recommended, and thus it is possible to prevent the document from being jammed in the apparatus main body 2 or the document from being sent out far.

Modifications of the embodiment described above will be described below.

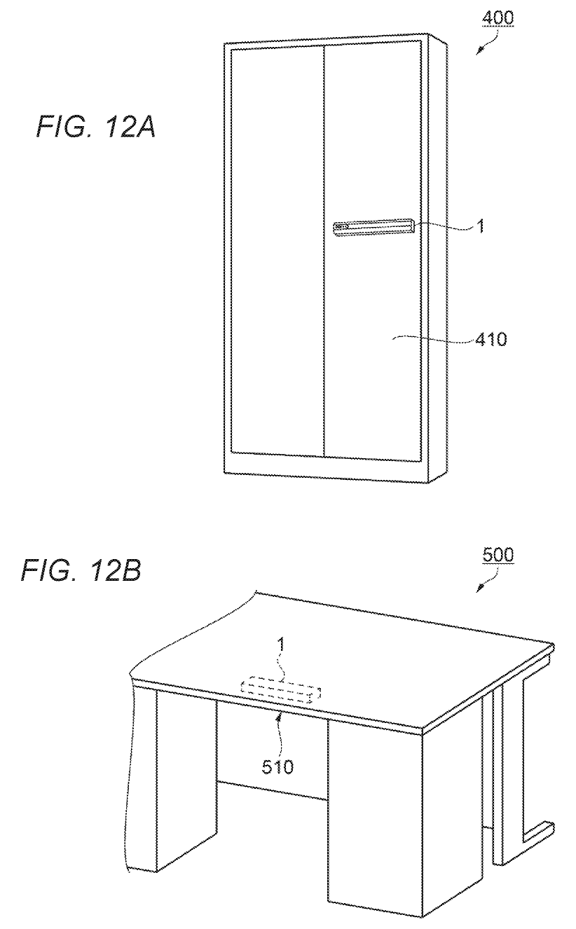

As described above, the magnet 100 is not limited to being disposed inside the housing, that is, inside the apparatus main body 2, and may be disposed as illustrated in FIGS. 13 to 15.

As illustrated in FIG. 13, a scanner 1A of the modification includes a cover portion 610 that is detachable from an apparatus main body 2A. A magnet 100 is disposed in the cover portion 610. The magnet 100 can be disposed on the outer surface of the apparatus main body 2A by sliding and fitting the convex portion provided on the cover portion 610 into the concave portion provided on the apparatus main body 2A.

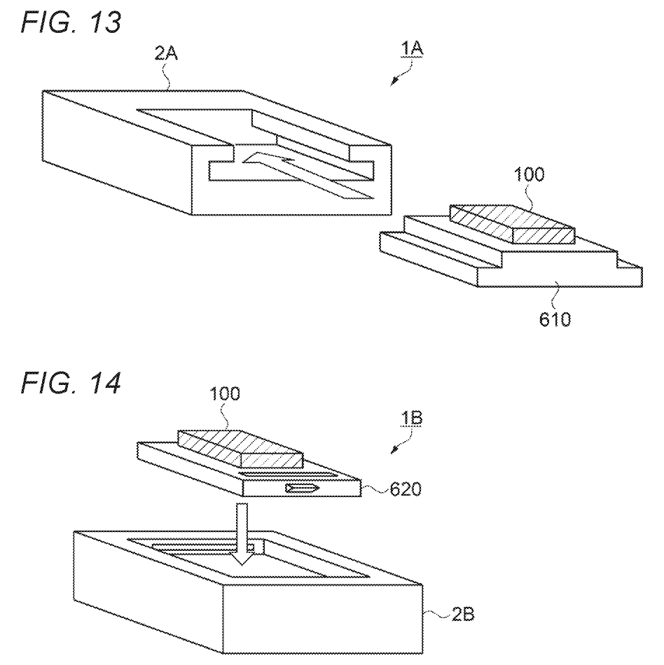

As illustrated in FIG. 14, a scanner 1B of the modification includes a cover portion 620 that is detachable from an apparatus main body 2B. A magnet 100 is disposed in the cover portion 620. The magnet 100 can be disposed on the outer surface of the apparatus main body 2B by fitting the cover portion 620 into a recess provided in the apparatus main body 2B and having a size corresponding to the size of the cover portion 620 in a plan view.

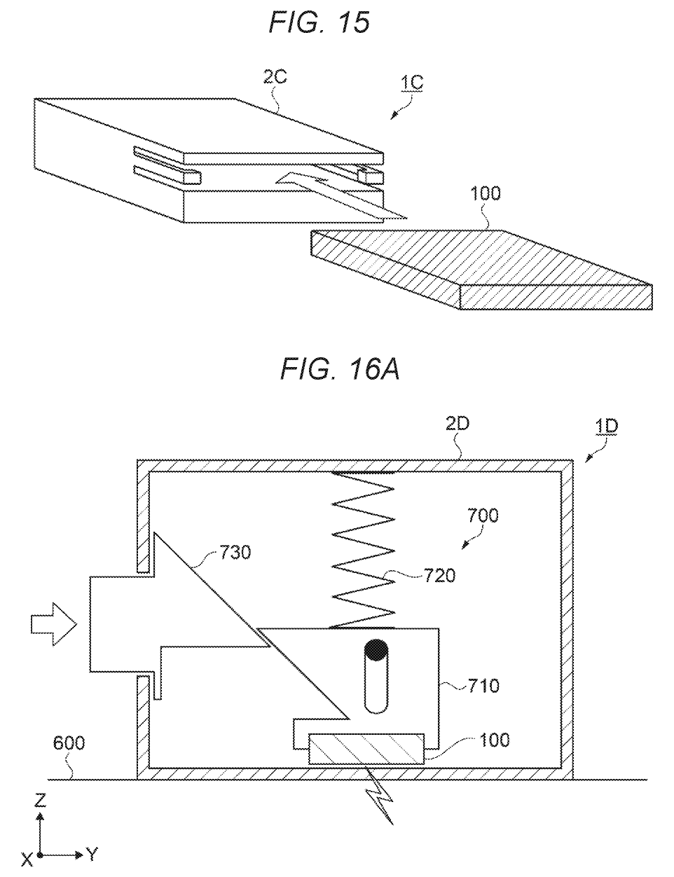

As illustrated in FIG. 15, a scanner 1C of the modification includes a magnet 100 that is detachable from an apparatus main body 2C. The apparatus main body 2C is provided with a recess for housing the magnet 100 and a pin for holding the magnet 100. The magnet 100 is slidingly inserted into the recess and the magnet 100 is fixed by an elastic pin.

As described above, as illustrated in FIGS. 13 and 14, it is preferable that the cover portions 610 and 620 detachable from the apparatus main bodies 2A and 2B are provided, and the magnets 100 are disposed in the cover portions 610 and 620. According to the configuration, since the magnets 100 are disposed in the detachable cover portions 610 and 620, when the magnets 100 are not required, for example, when the apparatuses are used on desks or stored, the magnets 100 are removed, so that spaces can be effectively used. Further, for carrying, the sizes can be reduced or the weights can be reduced by removing the magnets 100. In this way, it is possible to flexibly respond to the needs of the user.

As illustrated in FIGS. 13 and 14, the magnets 100 are preferably disposed on the outer surfaces of the apparatus main bodies 2A and 2B. According to the configuration, since the magnets 100 are disposed on the outer surfaces of the apparatus main bodies 2A and 2B, it is easy to notify the user that the apparatus main bodies can be attached to magnetic materials.

As described above, the magnet 100 is not limited to being fixed onto the lower housing 3 of the apparatus main body 2, and may be configured as illustrated in FIGS. 16A and 16B. As illustrated in FIGS. 16A and 16B, a scanner 1D of the modification includes a moving mechanism 700 that moves the magnet 100 in a direction away from the installation surface 600.

The moving mechanism 700 includes, inside an apparatus main body 2D, a support portion 710 that supports the magnet 100, a biasing member 720 for separating the magnet 100 from the installation surface 600, and a pressing portion 730 exposed to the outside of the apparatus main body 2C. The biasing member 720 is coupled to the support portion 710 and the inside of the apparatus main body 2C, and is biased toward the support portion 710. The pressing portion 730 is in contact with the support portion 710, and a part thereof protrudes to the outside of the apparatus main body 2C. As illustrated in FIGS. 16A and 16B, the support portion 710 is cut out to have an inclined surface inclined downward in the pressing direction in which the pressing portion 730 is pressed. The pressing portion 730 has a contact surface contactable with the inclined surface of the support portion 710.

As illustrated in FIG. 16A, when the user wishes to detach the scanner 1D attached to the installation surface 600 by the magnet 100, the user presses the pressing portion 730. When the pressing portion 730 is pressed, the inclined surface and the contact surface slide, and as illustrated in FIG. 16B, the support portion 710 moves in a direction away from the installation surface 600. In other words, when the pressing portion 730 is pressed in the pressing direction, the support portion 710 moves in the Z direction. Accordingly, the magnet 100 fixed to the support portion 710 is separated from the installation surface 600 side, and the scanner 1D can be easily detached from the installation surface 600. When the pressing portion 730 is no longer pressed in the pressing direction, the inclined surface and the contact surface slide, and the support portion 710 moves in a direction toward the installation surface 600 side. Accordingly, the magnet 100 fixed to the support portion 710 moves closer to the installation surface 600, and the scanner 1D can be attached to the installation surface 600.

As described above, it is preferable that the scanner 1D according to the modification includes the moving mechanism 700 that moves the magnet 100 in the direction away from the installation surface 600, the moving mechanism 700 includes the support portion 710 that supports the magnet 100 inside the apparatus main body 2C, the biasing member 720 that is coupled to the support portion 710 and the apparatus main body 2C inside the apparatus main body 2C and is biased in the direction toward the support portion 710, and the pressing portion 730 that comes into contact with the support portion 710 inside the apparatus main body 2C and partially protrudes to the outside of the apparatus main body 2C, and the magnet 100 moves in the direction away from the installation surface 600 when the pressing portion 730 is pressed in the direction toward the apparatus main body 2C. According to the configuration, since the moving mechanism 700 is provided, when the user presses the pressing portion 730, the magnet 100 and the installation surface 600 as a magnetic material can be separated from each other, and the apparatus main body 2C can be easily detached from the installation surface 600.

As described above, the number of magnets 100 disposed in the scanner 1 is not limited to two and may be one or three or more. The sum of the holding forces of the magnets 100 is equal to or greater than the weight of the apparatus main body 2C.

What is claimed is:

1. An image reading apparatus comprising:
a reading unit that reads an image of a document;
a document conveyance unit that is disposed at a position facing the reading unit and conveys the document;
a housing that houses the reading unit and the document conveyance unit;
an operation unit that is disposed in the housing and is operable by a user; and
a magnet capable of holding an apparatus main body including the reading unit, the document conveyance unit, and the housing on a magnetic material, wherein
the reading unit and the document conveyance unit are disposed between the operation unit and the magnet in a direction intersecting an installation surface of the apparatus main body, and
a holding force of the magnet is larger than a weight of the apparatus main body.

2. The image reading apparatus according to claim 1, wherein
the magnet is disposed inside the housing.

3. The image reading apparatus according to claim 1, further comprising a cover portion detachable from the housing, wherein
the magnet is disposed in the cover portion.

4. The image reading apparatus according to claim 1, wherein
the magnet is disposed on an outer surface of the housing.

5. The image reading apparatus according to claim 1, further comprising:
a document ejection port that ejects the document; and
a reversing member that is detachably disposed near the document ejection port, comes into contact with a leading end of the document ejected from the document ejection port, and sends out the document in a direction opposite to a direction in which the document is ejected.

6. The image reading apparatus according to claim 5, further comprising:
a detection unit that detects an attitude of the apparatus main body; and
a control unit that performs control based on a detection result of the detection unit, wherein
the control unit causes the operation unit to perform display related to attachment and detachment of the reversing member based on the detection result.

7. The image reading apparatus according to claim 6, wherein
the detection unit is a gyro sensor.

8. The image reading apparatus according to claim 6, wherein
when the detection unit determines that the attitude of the apparatus main body is a first attitude, the control unit causes the operation unit to display a recommendation to attach the reversing member.

9. The image reading apparatus according to claim 1, further comprising a moving mechanism that moves the magnet in a direction away from the installation surface, wherein
the moving mechanism includes:
a support portion that supports the magnet inside the housing;
a biasing member coupled to the support portion and the housing inside the housing and biased in a direction toward the support portion; and
a pressing portion in contact with the support portion inside the housing and partially protruding outside the housing, and
the magnet moves in the direction away from the installation surface when the pressing portion is pressed in a direction toward the housing.
